(19) United States
(12) Patent Application Publication
(10) Pub. No.: US 2026/0029974 A1
(43) Pub. Date: Jan. 29, 2026

(54) IMAGE FORMING APPARATUS TRANSMITTING STATUS INFORMATION TO USB-CONNECTED TERMINAL DEVICE VIA CONTROL ENDPOINT OF USB INTERFACE

(71) Applicant: BROTHER KOGYO KABUSHIKI KAISHA, Nagoya (JP)

(72) Inventor: Kenshiro NAKAJIMA, Kani (JP)

(73) Assignee: BROTHER KOGYO KABUSHIKI KAISHA, Nagoya (JP)

(21) Appl. No.: 19/274,151

(22) Filed: Jul. 18, 2025

(30) Foreign Application Priority Data
Jul. 26, 2024 (JP) 2024-120913

(51) Int. Cl. G06F 3/12

(52) U.S. Cl. CPC G06F 3/128; G06F 3/121; G06F 3/1235; G06F 3/1236; G06F 3/1274; G06F 3/1296

(57) ABSTRACT

An image forming apparatus includes a Universal Serial Bus (USB) interface and a controller. The USB interface includes a control endpoint for control transfer and a data endpoint for data transfer. The controller is configured to transmit, in response to receiving a status request command from a USB-connected terminal device through the control endpoint, status information of the image forming apparatus to the USB-connected terminal device through the control endpoint. The USB-connected terminal device is a terminal device connected to the image forming apparatus through a USB connection.

### REFERENCE TO RELATED APPLICATIONS

This application claims priority from Japanese Patent Application No. 2024-120913 filed on Jul. 26, 2024. The entire content of the priority application is incorporated herein by reference.

### BACKGROUND ART

A known image forming apparatus prints an image on a sheet, which is an object to be printed. When a PC or other external terminal serving as a host is connected to such an image forming apparatus, the external terminal can control the image forming apparatus to print by transmitting printing instructions and can check the current status of the image forming apparatus. As one method for connecting an image forming apparatus and an external terminal, a connection environment using Universal Serial Bus (USB) has been employed.

Although physically a serial communication, USB includes endpoints, which serve as terminal points of logical channels. By providing a plurality of such endpoints, a plurality of communication channels at the software level (referred to as “pipes”) can be formed in a single cable. In a known image forming apparatus connected to an external terminal through a USB connection, when a predetermined operation to execute a print is performed on the host-side external terminal, the external terminal transmits print data to the device-side image forming apparatus via one of the pipes described above in order to execute a printing process on the image forming apparatus.

### SUMMARY

In addition to such print data, data transmitted from the host-side external terminal to the device-side image forming apparatus may include commands for instructing the image forming apparatus. However, when print data and commands are transmitted over the same pipe while the preceding print data is still unprocessed for any reason and is retained in the pipe or on the image forming apparatus, the image forming apparatus cannot process the transmitted commands. Such a retention of print data can occur when the image forming apparatus is unable to print due to a paper jam or the depletion of consumables or when the external terminal has transmitted a large volume of print data that takes time to transmit.

In view of the foregoing, it is an object of the present disclosure to provide an image forming apparatus and an image forming system that can process commands even in a state in which a retention of print data has occurred, as described above.

In order to attain the above and other objects, according to one aspect, the present disclosure provides an image forming apparatus including a Universal Serial Bus (USB) interface and a controller. The USB interface includes a control endpoint for control transfer; and a data endpoint for data transfer. The controller is configured to perform: transmitting, in response to receiving a status request command from a USB-connected terminal device through the control endpoint, status information of the image forming apparatus to the USB-connected terminal device through the control endpoint. The USB-connected terminal device is a terminal device connected to the image forming apparatus through a USB connection.

According to another aspect, the present disclosure provides an image forming apparatus including a Universal Serial Bus (USB) interface and a controller. The USB interface includes a control endpoint for control transfer and a data endpoint for data transfer. The controller is configured to perform: canceling, in response to receiving a print cancellation command from a USB-connected terminal device through the control endpoint while a printing process is in progress, the printing process in progress. The USB-connected terminal device is a terminal device connected to the image forming apparatus through a USB connection.

According to still another aspect, the present disclosure provides an image forming system including an image forming apparatus and a terminal device. The terminal device is connected to the image forming apparatus through a Universal Serial Bus (USB) interface. The USB interface includes a control endpoint for control transfer and a data endpoint for data transfer. The terminal device is configured to perform: transmitting a status request command to the image forming apparatus through the control endpoint; and transmitting print data to the image forming apparatus through the data endpoint. The image forming apparatus is configured to perform: transmitting, in response to receiving the status request command from the terminal device through the control endpoint, status information of the image forming apparatus to the terminal device through the control endpoint.

With the configurations of the above-described image forming apparatus and image forming system, the image-forming apparatus and an external terminal connected through USB can exchange commands through a pipe connecting to the endpoint for control transfer, which differ from the endpoint used for exchanging print data. Therefore, even when print data transmitted from the host-side external terminal to the device-side image forming apparatus becomes retained in the pipe due to any of various reasons, such as the transmitted print data being of a large size that requires time to transmit or the printing process being suspended by a sheet jam or the depletion of a consumable, the image forming apparatus can still process various commands via the endpoint for control transfer. Additionally, commands can be exchanged via the existing endpoint for control transfer without establishing a new endpoint dedicated to transmitting commands. Moreover, this arrangement does not complicate the USB interface configuration since bi-directional communication can be performed on the pipe connecting to the endpoint for control transfer.

By transmitting the status request command in particular, the terminal device can obtain status information from the image-forming device at any timing. By transmitting the print cancellation command, the terminal device can cancel a print at any timing. In other words, the terminal device can be given the same functionality for canceling a print as when a cancellation operation is performed directly through an operation on the body of the image-forming apparatus.

### BRIEF DESCRIPTION OF DRAWINGS

FIG. 1 is a view illustrating an outline of the configuration of an image forming system.

FIG. 2 is a schematic diagram illustrating an outline of the internal structure of a printer.

FIG. 3 is a schematic diagram illustrating endpoints of USB interfaces and pipes that connect the endpoints.

FIG. 4 is a flowchart illustrating steps in a first main process.

FIG. 5 is a flowchart illustrating steps in a second main process.

### DESCRIPTION

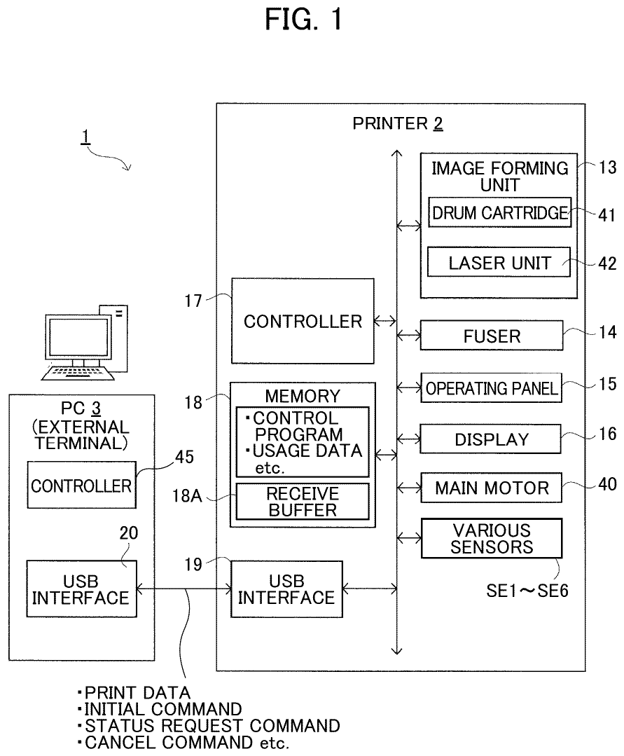

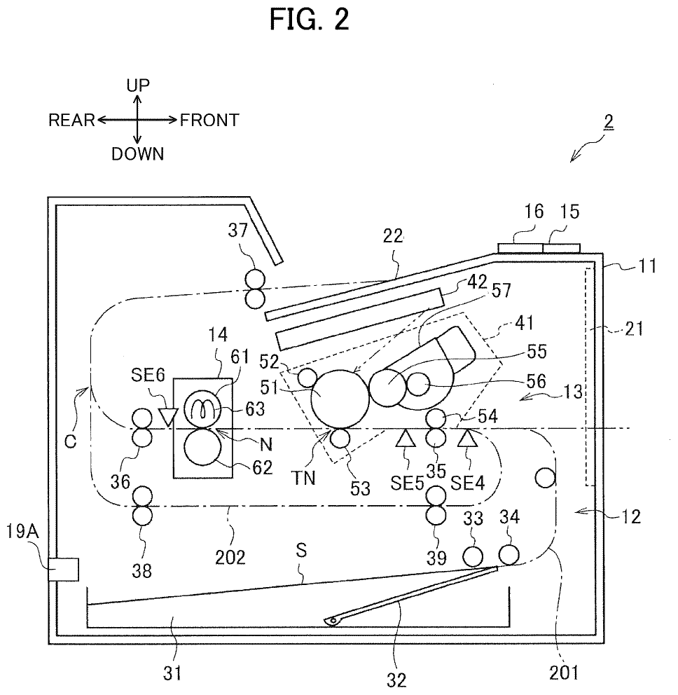

Below, image forming apparatuses and image forming systems according to embodiments of the present disclosure will be described while referring to the accompanying drawings. FIG. 1 shows the overall configuration of an image forming system 1 according to an embodiment of the present disclosure. FIG. 2 shows a simplified internal configuration of a printer 2, which is an image forming apparatus included in the image forming system 1.

### Overall Configuration of the Image Forming System

As shown in FIG. 1, the image forming system 1 according to the present embodiment includes the printer 2, and a personal computer (PC) 3. The PC 3 is an external terminal that is connected to the printer 2 through a Universal Serial Bus (USB) connection. As an example, the image forming system 1 can be used for self-service teller terminals provided by financial institutes, such as a Video Teller Machine. In this case, the PC 3 corresponds to the PC terminal that the user operates at the self-service teller kiosk, and the printer 2 and PC 3 may be accommodated in the same device case. However, the image forming system 1 is not limited to such applications. For example, instead of the PC 3, the external terminal may be a smartphone, tablet computer, or other portable information terminal.

As for the relationship between the printer 2 and the PC 3, the printer 2 functions as the device side, and the PC 3 functions as the host side. Further, both the printer 2 and PC 3 include various communication interfaces in addition to a USB interface and can be connected to each other by various communication methods such as wired LAN, wireless LAN, and Bluetooth in addition to a USB connection. However, the following description will assume that the printer 2 and PC 3 are connected via a USB connection.

In this embodiment, the printer 2 is a monochrome laser printer that forms single-color developer images on sheets S, but the printer 2 is not limited to this configuration. For example, the printer 2 may be a color laser printer that forms multicolor developer images on sheets S. Alternatively, the printer 2 may be an inkjet printer that prints on sheets S. To facilitate the following description, the up-down and front-rear directions relative to the printer 2 are defined as indicated by the arrows depicted in FIG. 2. The printer 2 is an example of the image forming apparatus configured to print images on sheets S. Examples of the sheet S include recording paper and overhead projector (OHP) sheets. The sheet S is an example of the recording medium.

As shown in FIGS. 1 and 2, the printer 2 includes a main casing 11, a sheet-conveying unit 12, an image forming unit 13, a fuser 14, an operating panel 15, a display 16, a controller 17, a memory 18, and a USB interface 19. The USB interface 19 includes a connector 19A. The main casing 11 accommodates the above components. Next, the components of the printer 2 will be described one by one.

The main casing 11 is a housing part that forms the exterior of the printer 2. The operating panel 15, the display 16, and the connector 19A are disposed on an outer wall of the main casing 11. The connector 19A is a portion into which a USB connection cable can be inserted.

The main casing 11 includes a front cover 21, a discharge tray 22, and a supply tray 31. The front cover 21 is attached to the front surface of the main casing 11 and can be opened and closed. The discharge tray 22 is disposed on the top portion of the main casing 11. Sheets S on which images have been formed are to be supported in the discharge tray 22. The supply tray 31 is removably mounted in the bottom portion of the main casing 11. Sheets S are to be placed on the supply tray 31. The sheets S are standard size sheets, such as A4-size sheets, for example. The sheets S are paper media, such as plain paper or cardstock, but are not limited to paper. For example, the sheets S may be OHP films. The supply tray 31 is an example of the sheet tray in the present disclosure.

The printer 2 includes a sensor SE1 configured to detect the open and closed state of the front cover 21, and a sensor SE2 configured to detect the open and closed state of the supply tray 31. The printer 2 also includes a sensor SE3 for detecting the approximate remaining number of sheets S in the supply tray 31.

The sheet-conveying unit 12 is a mechanism for conveying sheets S in the printer 2. The paths in the sheet-conveying unit 12 along which the sheets S are conveyed are divided into a conveying path 201, and a re-conveying path 202. The conveying path 201 functions to convey sheets S loaded in the supply tray 31 toward the discharge tray 22 via the image forming unit 13. The re-conveying path 202, on the other hand, functions to convey sheets S with an image formed on one side in the direction opposite the conveying direction and then to re-convey the sheets S toward the image forming unit 13 (i.e., for double-sided printing). The re-conveying path 202 branches off the conveying path 201 at a divergence point C and then re-joins the conveying path 201 near a pre-registration sensor SE4.

The sheet-conveying unit 12 includes a pickup roller 33, a separating roller 34, a registration roller 35, conveying rollers 36, discharge rollers 37, re-conveying rollers 38 and 39, and a main motor 40 (see FIG. 1) as the drive source of these rollers.

The pickup roller 33 picks up sheets S in the supply tray 31 which have been pushed upward by a sheet-pressing plate 32, and conveys these sheets S toward the conveying path 201. The separating roller 34 separates sheets S picked up by the pickup roller 33 so that the sheets S are conveyed one at a time.

The registration roller 35 is disposed upstream of the image forming unit 13 on the conveying path 201. The registration roller 35 first corrects the alignment of the front edge of the sheet S and then conveys the sheet S toward the image forming unit 13. The conveying rollers 36 convey the sheet S that has passed through the fuser 14 toward the discharge rollers 37.

The discharge rollers 37 are disposed downstream of the divergence point C on the conveying path 201. The discharge rollers 37 are a pair of rollers that include a drive roller and a follow roller. When rotated forward, the discharge rollers 37 discharge the sheet S onto the discharge tray 22. Forward rotation is the rotation that conveys the sheet S in the conveying direction, and corresponds to the counterclockwise rotation in FIG. 2 of the top discharge roller 37 about an axis extending in the left-right direction of the main casing 11.

The discharge rollers 37 rotates in reverse to convey sheets S onto the re-conveying path 202. This reverse rotation is the opposite rotational direction to the forward rotation. The reverse rotation is the rotation that conveys sheets S in the direction opposite the conveying direction, and corresponds to the clockwise rotation in FIG. 2 of the top discharge roller 37 about the axis extending in the left-right direction of the main casing 11.

The pairs of re-conveying rollers 38 and 39 are disposed along the re-conveying path 202. The re-conveying rollers 38 and 39 convey sheets S that have been conveyed onto the re-conveying path 202 toward the image forming unit 13. By re-conveying a sheet S having an image formed on one side of the sheet S back to the image forming unit 13 along the re-conveying path 202, image formation can be performed on both sides of the sheet S.

The sheet-conveying unit 12 includes various sensors for detecting the passage of sheets S. Specifically, the sheet-conveying unit 12 includes the pre-registration sensor SE4, a post-registration sensor SE5, and a discharge sensor SE6. For example, the pre-registration sensor SE4 is disposed upstream of the registration roller 35 on the conveying path 201. The pre-registration sensor SE4 is configured to detect the passage of a sheet S through the position of the pre-registration sensor SE4. The post-registration sensor SE5 is disposed upstream of the fuser 14 on the conveying path 201, and specifically between the registration roller 35 and a transfer roller 53 on the conveying path 201. The post-registration sensor SE5 is configured to detect the passage of a sheet S through the position of the post-registration sensor SE5. The discharge sensor SE6 is disposed between the fuser 14 and the conveying rollers 36 on the conveying path 201. The discharge sensor SE6 is configured to detect the passage of a sheet S through the position of the discharge sensor SE6. Based on the detection results of these sensors, the printer 2 can detect the occurrence of a sheet jam (e.g., a paper jam) on the conveying path and the occurrence of a sheet-out condition (e.g., a paper-out condition). In other words, based on the detection results of the above sensors, the printer 2 is configured to detect a state where a sheet jam (e.g., a paper jam) has occurred on the conveying path, and a state where the printer 2 has run out of sheets S (e.g., paper).

The image forming unit 13 is configured to form images on sheets S conveyed by the sheet-conveying unit 12. The image forming unit 13 includes a drum cartridge 41, and a laser unit 42. The drum cartridge 41 includes a photosensitive drum 51, a charging roller 52, the transfer roller 53, a pinch roller 54, a developing roller 55, a supply roller 56, and a toner accommodating unit (toner cartridge) 57. In a state where the front cover 21 is open, the drum cartridge 41 is attachable to and detachable from the device body. The pinch roller 54 of the drum cartridge 41 opposes the registration roller 35. Hence, the rotation of the registration roller 35 rotates the pinch roller 54, so that the registration roller 35 and the pinch roller 54 convey sheets S in cooperation with each other.

The photosensitive drum 51 rotates clockwise by receiving a drive force transmitted from the main motor 40 to convey sheets S in the conveying direction. The forward rotation of the photosensitive drum 51, which is the rotation for conveying sheets S in the conveying direction, is the clockwise direction in FIG. 2. The toner accommodating unit 57 accommodates toner. The supply roller 56 supplies toner from the toner accommodating unit 57 to the developing roller 55. The charging roller 52 applies a uniform charge to the surface of the photosensitive drum 51.

The transfer roller 53 is disposed in a position opposing the photosensitive drum 51. A transfer nip TN is formed between the transfer roller 53 and the photosensitive drum 51 in the conveying path 201. Note that a transfer belt may be used in place of the transfer roller 53.

The laser unit 42 is disposed in the upper portion of the main casing 11. Although not shown in the drawing, the laser unit 42 includes a polygon mirror, a laser light-emitting unit, lenses, reflecting mirrors, and other components. In the laser unit 42, the laser light-emitting unit emits laser light based on image data. The emitted laser light is scanned at high speed across the surface of the photosensitive drum 51. Through this high-speed scanning, the surface of the photosensitive drum 51 is exposed.

When the surface of the photosensitive drum 51 is exposed by the laser unit 42, an electrostatic latent image based on the image data is formed on the surface. The developing roller 55 supplies toner to the electrostatic latent image on the surface of the photosensitive drum 51 to form a toner image on the surface of the photosensitive drum 51.

A voltage application unit (not shown) applies a transfer voltage to the transfer roller 53. The transfer roller 53 transfers the toner image formed on the surface of the photosensitive drum 51 onto a sheet S passing through the transfer nip TN while conveying the sheet S in cooperation with the photosensitive drum 51. In this way, an image is formed on the sheet S.

The fuser 14 is disposed downstream of the image forming unit 13 on the conveying path 201. The fuser 14 includes a heating roller 61, a pressure roller 62, a heater 63, and a temperature sensor (not shown). The heating roller 61 heats a sheet S. The pressure roller 62 forms a nip between the pressure roller 62 and the heating roller 61 to apply pressure to the sheet S. The pressure roller 62 rotates in the counterclockwise direction in FIG. 2 by receiving the drive force of the main motor 40. This counterclockwise rotation is the forward rotation of the pressure roller 62 for conveying sheets S in the conveying direction.

The heater 63 is a halogen heater, for example, for heating the heating roller 61. The temperature sensor (not shown) is disposed in the vicinity of the heating roller 61 for detecting the temperature of the heating roller 61. The temperature sensor outputs, to the controller 17, signals corresponding to the detected temperature.

The fuser 14 is configured to fix an image formed on a sheet S by the image forming unit 13 to a sheet S. Specifically, the fuser 14 heats a sheet S using the heating roller 61 and rotates the heating roller 61, so that the heating roller 61 and the pressure roller 62 convey the sheet S while applying pressure to the sheet S. Through this operation, an image formed on the sheet S is fixed to the sheet S.

While the fuser 14 in the present embodiment includes the heating roller 61, pressure roller 62, and heater 63, the fuser 14 is not limited to this configuration. For example, the fuser 14 may include: a heater; a nip plate that receives radiant heat from the heater; a heating belt that circulates around the nip plate; and a pressure roller.

Alternatively, the fuser 14 may include: a substrate on which a heating pattern is formed; a belt that circulates around the substrate; and a pressure roller. In this case, the substrate and belt may be configured to contact each other. Alternatively, the fuser 14 may include: a heating roller; a heater; and a pressure belt.

Next, the control configuration of the printer 2 will be described with reference to FIG. 1. The controller 17 includes one or more processors, such as a Central Processing Unit (CPU), an application-specific integrated circuit (ASIC), and the like. The memory 18 is an embedded memory. The memory 18 may be configured by a combination of storage devices such as a Read-Only Memory (ROM), a Random Access Memory (RAM), a Non-Volatile RAM (NVRAM), a Solid-State Drive (SSD), and a Hard Disk Drive (HDD). ROM, RAM, and NVRAM disposed in the controller 17 for use when executing various programs may also be considered part of the memory 18. In the present disclosure, the term “processor” encompasses both a single processor or a group of multiple processors located either locally or remotely working together or in a distributed fashion to collectively perform the tasks attributed to the “processor” described herein.

A storage medium that is readable by the controller 17 is a non-transitory medium. In addition to the above examples, examples of a non-transitory medium include a CD-ROM, a DVD-ROM, and other types of storage media. A non-transitory medium is also a tangible medium. On the other hand, electric signals that convey programs downloaded from a server or the like on the Internet are a computer-readable signal medium, which is one type of a computer-readable storage medium but is not considered a non-transitory computer-readable storage medium. The memory 18 is an example of the computer-readable storage medium.

Programs that can be executed by the controller 17 are stored in the memory 18. In the following description of the embodiment will describe processes performed by the controller 17 in accordance with instructions described in the programs. In other words, in the following description, processes described using verbs, such as “determine,” “select,” “calculate,” “set,” “identify,” “obtain,” “receive,” and “control,” represent processes performed by the controller 17. Note that the term “obtain” is used as a concept that does not necessarily require a request. In other words, a process in which the controller 17 receives data without requesting that data is included in the concept of “the controller 17 obtains data.” Further, the term “data” described herein is expressed in bit strings that is readable by the controller 17. Data of different formats are treated as the same data when the content of the data is substantially the same. The same holds true for “information” in this specification.

In addition to the above programs, the memory 18 stores usage data on consumables. Examples of consumables on which usage data is recorded include the toner accommodating unit 57 (i.e., the toner cartridge) and the drum cartridge 41 (the photosensitive drum 51). In this case, examples of the usage data of the consumables include the quantity of toner remaining in the toner accommodating unit 57 (i.e., the toner cartridge), and the remaining life of the drum cartridge 41 (the photosensitive drum 51). That is, the usage data indicates the extent to which a consumable has been used. For example, the usage data may be the number of pages that have been printed to date since the last replacement of the consumable, and the percentage of the number of printed pages relative to the reference threshold for replacement of the consumable. The usage time may be stored as the usage data instead of the number of printed pages. In the present embodiment, usage data stored in the memory 18 is transmitted as status information of the printer 2 in response to a request from the PC 3.

The memory 18 includes a receive buffer 18A. The receive buffer 18A is a storage medium that temporarily stores data received from the PC 3. Examples of data that the printer 2 (the controller 17) receives from the PC 3 include print data, initial commands, status request commands, and cancel commands (print cancellation commands). The print data specifies the content of image formation to be executed by the printer 2. Print data includes Portable Document Format (PDF) data that uses a file format known as the Portable Document Format (PDF), for example. In PDF data, images are described using a page description language based on PostScript (“PostScript” is a registered trademark of ADOBE INC.), and multiple operators for drawing character strings, graphics, images, and the like are arranged in the processing order. On the other hand, the initial commands, the status request commands, and the cancel commands are data written in the Printer Job Language (PJL) and function to direct the printer 2 to perform prescribed processes. Details of these commands will be described later. Data stored in the receive buffer 18A is deleted after the relevant process is completed.

The display 16 is a liquid crystal display disposed on the main casing 11, and the operating panel 15 is a touchscreen or operating buttons, for example. The display 16 and operating panel 15 together function as a user interface that is between the controller 17 and the user operating the printer 2, provides various information to the user, and receives user operations.

The USB interface 19 is a type of communication interface. When the USB interface 19 is connected to a USB interface 20 in the PC 3 via a USB connection cable, the printer 2 can communicate with the PC 3. The controller 17 can receive data transmitted from the USB interface 20 of the PC 3 via the USB connection cable. Data received from the USB interface 20 is stored in the receive buffer 18A.

In addition to the USB interface 20, the PC 3 includes a controller 45 that includes one or more processors, such as a CPUs, a GPU, and the like, for executing arithmetic processes. While not shown, the PC 3 further includes: storage media such as ROM, RAM, and HDD; a display or other displaying means; and a keyboard, mouse, and other operating means. In a state where the PC 3 is connected to the printer 2, the PC 3 transmits print data, status request commands, cancel commands, and the like to the printer 2.

These commands and data may be transmitted in response to a user operation on the PC 3 or independently of a user operation. For example, the PC 3 (the controller 45) transmits print data to the printer 2 in response to receiving a print instruction from the user in a state where a printer driver for the printer 2 is installed on the PC 3. Further, for example, the PC 3 (the controller 45) transmits a status request command to the printer 2 at one or more of the following timings: in response to a fixed period of time having elapsed after the PC 3 is connected to the printer 2; before a printing process is executed (after receiving a print instruction but before transmitting the print data); and in response to a predetermined period of time having elapsed after transmitting the print data. Note that the concept of “the PC 3 transmits a status request command to the printer 2 in response to a fixed period of time having elapsed after the PC 3 is connected to the printer 2” is may encompass (but does not necessarily encompass) the PC 3 transmitting a status request command to the printer 2 in response to a fixed period of time having elapsed after the previous command is transmitted (i.e., the PC 3 transmitting a status request command to the printer 2 at repeated intervals of the fixed period of time after the PC 3 is connected to the printer 2). Further, for example, the PC 3 (the controller 45) transmits a cancel command to the printer 2 in response to receiving a print cancellation operation from the user after receiving the above print instruction.

### Configuration of the USB Interface

Next, the USB interface 19 of the printer 2 and the USB interface 20 of the PC 3 will be described. The PC 3 on the host side and the printer 2 on the device side are connected using a single USB cable. However, multiple communication channels can be formed within this single cable in software, enabling data transmissions to be multiplexed. In the following description, each of these virtual multiplexed transmission channels will be called a “pipe.”

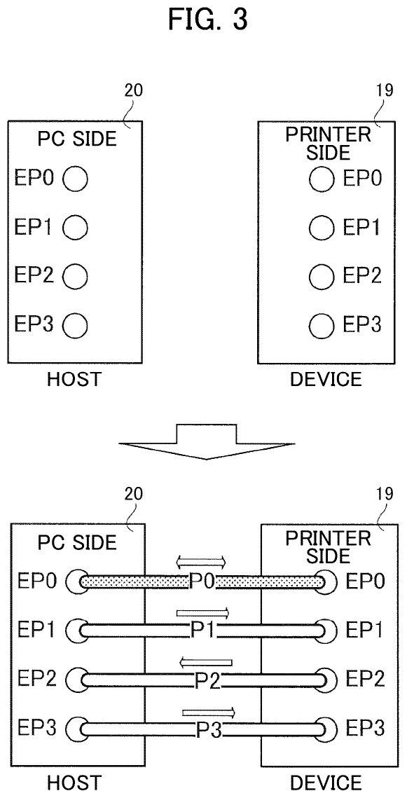

As shown in FIG. 3, the USB interface 19 disposed in the printer 2 and the USB interface 20 disposed in the PC 3 each include endpoints that serve as terminals of logical channels. While four endpoints EP0-EP3 are provided in the example shown in FIG. 3, the number of endpoints is not limited to four but may be three or less or five or more. Upon connection of the device (the printer 2) and the host (the PC 3) via USB, the device and the host exchange initial commands. Through this exchange, the device side notifies the host side of the device's interface configuration (what functions the device possesses and how many endpoints the device uses to implement those functions). The host then assigns the host's endpoints to open pipes and assigns an appropriate class driver. As a result, pipes connecting the device's endpoints and the host's endpoints are formed, thereby enabling data transmission via the pipes and endpoints thereafter.

A USB interface always includes endpoint 0 (EP0) as an endpoint. Endpoint 0 (EP0) is a dedicated endpoint for exchanging basic information (control transfers) between the host and the device. The pipe that connects both endpoints 0 (EP0) is called the control transfer pipe (P0 in FIG. 3). Pipes other than the control transfer pipe (P1-P3 in FIG. 3) includes IN pipes for inputting data from the device side into the host side, and OUT pipes for outputting data from the host side to the device side. Further, the control transfer pipe P0 is a bi-directional pipe that allows data to be transmitted and received over the same pipe, while the other pipes P1-P3 are unidirectional pipes in which data flows only in a predetermined direction (the direction of input to the host side in an IN pipe and the direction of output from the host side in an OUT pipe). While the example in FIG. 3 shows EP1 connected to EP1, EP2 to EP2, and EP3 to EP3, the endpoints for the pipes (pipes P1-P3) other than the control transfer pipe P0 are not fixed and can be changed each time a connection is established. The endpoint EP0 of the USB interface 19 is an example of the control endpoint for control transfer in the present disclosure. The endpoints EP1-EP3 of the USB interface 19 are each an example of the data endpoint for data transfer in the present disclosure. The endpoint EP0 of the USB interface 20 is an example of the control endpoint for control transfer in the present disclosure. The endpoints EP1-EP3 of the USB interface 20 are each an example of the data endpoint for data transfer in the present disclosure.

The control transfer pipe P0 is defined to have a smaller maximum volume (e.g., 1024 bytes) of data that can be transmitted in a single transaction, compared to the other pipes P1-P3. Further, data transmitted over the control transfer pipe P0 is defined to have processing priority over data transmitted on the other pipes P1-P3. When no reply is received within a predetermined period of time after a command is transmitted over the control transfer pipe P0, a timeout process is performed (return a NACK). In other words, typically, data transfers using the control transfer pipe P0 do not cause data to remain buffered or unprocessed.

As described above, data that is exchanged between the printer 2 and PC 3 in this embodiment is the print data, initial commands, status request commands, cancel commands, and other data. In this embodiment, print data is to be transmitted using any of the pipes (i.e., the pipes P1-P3) other than the control transfer pipe P0, and the initial commands, status request comments, and cancel commands are to be transmitted using the control transfer pipe P0. The status request command is a command requesting the printer 2 to transmit (return) the status information of the printer 2 to the PC 3. Examples of the status information include information on consumables used in the printer 2, information on the current status of the printer 2 such as “printing” or “error,” etc. The cancel command (i.e., the print cancellation command) is a command instructing the printer 2 to cancel a printing process. The cancel command is an example of the print cancellation command of the present disclosure.

In situations in which a printing process cannot be executed due to a sheet jam (e.g., a paper jam) or the depletion of a consumable or in which print data being transmitted is of a large volume that requires time to transmit, for example, print data may become buffered in the pipe or remain unprocessed and retained in the printer (i.e., remain unprocessed in the receive buffer 18A). Therefore, if a status request command or a cancel command were transmitted over the same pipe used for transmitting print data, the printer 2 would be unable to process the command while print data sent earlier remains buffered, as described above. Hence, the PC 3 would be unable to obtain the status information from the printer 2 or cancel a printing process.

However, since the control transfer pipe has the characteristics described above, typically, data is not buffered in data transmission over the control transfer pipe. Therefore, data for initial commands, status request commands, and cancel commands are transmitted using the control transfer pipe in this embodiment. Moreover, the status information which the printer 2 returns is also to be transmitted using the control transfer pipe, as with the status request command. This enables the printer 2 to immediately process a status request command or a cancel command received from the PC 3, even under circumstances in which print data is buffered (more specifically, while print data is being received; after print data has been received but while the print data is being stored in the receive buffer 18A; after print data has been received but while a suspension condition is present in a printing process based on the received print data; etc.), and enables the PC 3 to obtain status information or cancel printing at a desired timing. The suspension condition is a condition under which the printing process is to be suspended.

### Control Process by the Controller

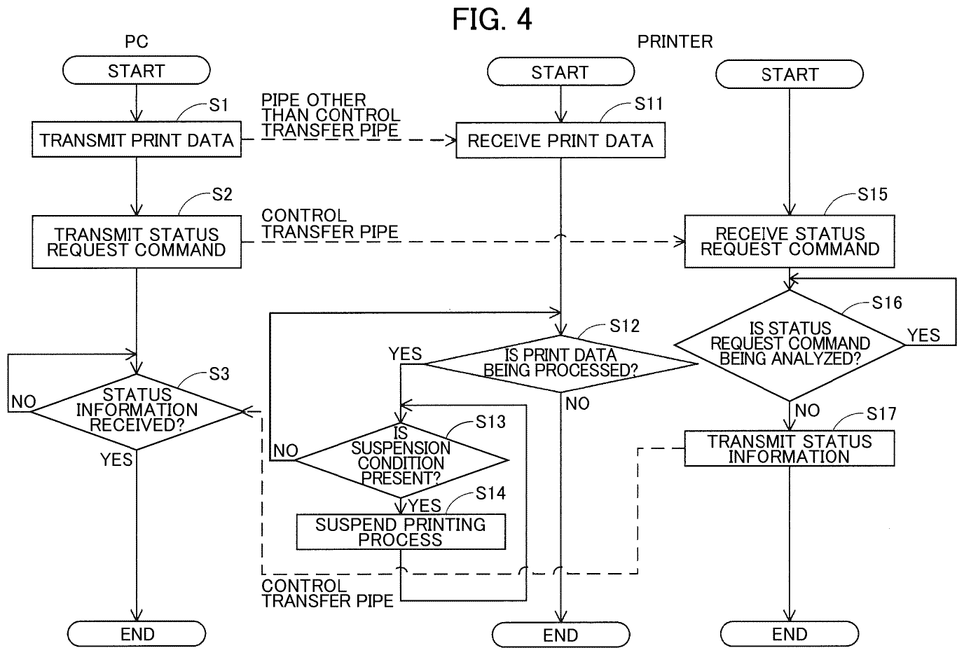

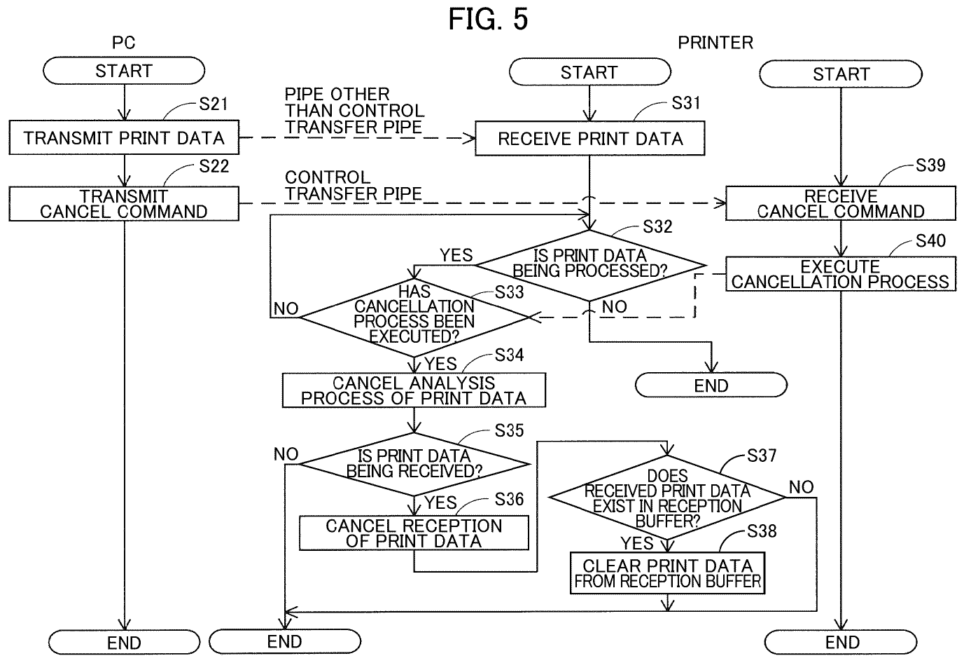

Next, among various control processes executed by the controller 17 of the printer 2 having the above configuration, control processes that are executed based on print data and commands received from the PC 3 will be described, together with processes executed on the PC 3, with reference to FIGS. 4 and 5. FIGS. 4 and 5 are both flowcharts illustrating steps in a main process performed by the printer 2. The main process is executed after the power to the printer 2 has been turned on. The flowchart in FIG. 4 shows a control process executed in the main process when the printer 2 receives print data and a status request command. The flowchart in FIG. 5 shows the control process executed in the main process when the printer 2 receives print data and a cancel command. Programs for executing the following processes illustrated in the flowcharts of FIGS. 4 and 5 are stored in the memory 18 of the printer 2 and a memory of the PC 3 and are respectively executed by the controller 17 of the printer 2 and the controller 45 of the PC 3.

A control process for a case in which the printer 2 receives print data and a status request command from the PC 3 will be described, as a first working example, with reference to FIG. 4. The following description assumes that the printer 2 and PC 3 are connected by a USB connection cable and the aforementioned pipes between the endpoints (see FIG. 3) have been formed. The PC 3 is an example of the terminal device in the present disclosure. The PC 3 connected to the printer 2 through a USB connection is an example of the USB-connected terminal device in the present disclosure.

First, the process performed by the PC 3 will be described. In the following description, “step” will be abbreviated as “S”. In S1 the controller 45 transmits print data to the printer 2. Print data represents the content of image formation to be performed by the printer 2 and includes image data such as PDF data. This print data may also be referred to as a print job. For example, the controller 45 transmits print data in S1 in response to receiving a print instruction from the user in a state where a printer driver for the printer 2 is installed on the PC 3. However, independently of user operations, the controller 45 can also transmit print data in response to a predetermined condition being met.

When transmitting print data in S1, the controller 45 uses an OUT pipe (e.g., P1) from among the pipes shown in FIG. 3, excluding the control transfer pipe P0. An OUT pipe denotes a pipe for outputting data from the host side. In this embodiment, the controller 45 uses the pipe P1 for transmission of print data. In other words, the controller 45 transmits print data to the printer 2 through the endpoint EP1 of the USB interface 20.

In S2 the controller 45 then transmits the status request command to the printer 2. The status request command is data described in the Printer Job Language (PJL), and specifically a command requesting the current status information of the printer 2. The current status information may be information on consumables used in the printer 2, and the current status of the printer 2 (e.g., “printing” or “error”). For example, in S2 the PC 3 transmits a status request command to the printer 2 at one or more of the following timings: in response to a fixed period of time having elapsed after the PC 3 is connected to the printer 2; before a printing process is executed (after receiving a print instruction but before transmitting the print data); and in response to a predetermined period of time having elapsed after transmitting the print data. Note that the concept of “the PC 3 transmits a status request command to the printer 2 in response to a fixed period of time having elapsed after the PC 3 is connected to the printer 2” may encompass (but does not necessarily encompass) the PC 3 transmitting a status request command to the printer 2 in response to a fixed period of time having elapsed after the previous command is transmitted (i.e., the PC 3 transmitting a status request command to the printer 2 at repeated intervals of the fixed period of time after the PC 3 is connected to the printer 2).

Data for the status request command is transmitted in S2 using the control transfer pipe P0, as shown in FIG. 3. In other words, the controller 45 transmits the status request command to the printer 2 through the endpoint EP0 (endpoint 0) of the USB interface 20.

The status request command is transmitted in S2 after transmitting the print data in S1 in the flowchart shown in FIG. 4. However, as described above, the triggers for transmitting the status request command may be a time prior to transmitting the print data, or may be independent of the transmission of the print data. Therefore, the order that each step is executed is not limited to the order beginning from the smallest step number.

In S3 the controller 45 determines whether status information as a response to the status request command sent in S2 has been received from the printer 2. The status information that the printer 2 returns to the PC 3 is transmitted over the control transfer pipe P0, as with the status request command. In other words, in response to receiving the status request command from the PC 3 through the endpoint EP0 (endpoint 0) of the USB interface 19, the printer 2 transmits the status information to the PC 3 through the endpoint EP0 (endpoint 0) of the USB interface 19.

When determining that the status information has not been received from the printer 2 (S3: NO), the controller 45 waits for the status information to be received while repeating the process in S3. On the other hand, when determining that the status information has been received from the printer 2 (S3: YES), the controller 45 ends the process in FIG. 4.

Note that the controller 45 may provide guidance to the user regarding the status information received in S3 and may reflect the status information in the processing content of the PC 3 as appropriate.

For example, the following process can be performed when information on various consumables used in the printer 2 is received as the status information. As a specific example, in a case where the controller 45 obtains the remaining number of sheets (e.g., the remaining quantity of paper) accommodated in the printer 2 as the status information, the controller 45 displays the current remaining number of sheets on the screen of the PC 3. In particular, the controller 45 warns the user when the remaining number of sheets is low or when the printer 2 is run out of sheets S. As another example, in a case where the controller 45 obtains the quantity of toner remaining in the toner accommodating unit 57 (e.g., the toner cartridge) mounted in the printer 2 as the status information, the controller 45 displays the current remaining quantity of toner on the display of the PC 3. In particular, the controller 45 warns the user when toner is low or when the printer 2 is out of toner. As another example, in a case where the controller 45 obtains the remaining life of the drum cartridge 41 mounted in the printer 2 as the status information, the controller 45 displays the current remaining life of the drum cartridge 41, such as the estimated time for replacement or the approximate number of pages that can be printed in the remaining life, on the display of the PC 3. In particular, the controller 45 warns the user when the replacement time is approaching or when the replacement time has arrived.

Note that the controller 45 need not necessarily obtain all the above-described information as information on the consumables used in the printer 2 but may obtain some of the above-described information.

Alternatively to or in addition to the above information on consumables, in a case where the controller 45 obtains information on the current status of the printer 2 as the status information, the controller 45 need not perform any particular process when the printer 2 is in a normal state. However, when the controller 45 obtains the status information indicating that a suspension condition is present in a printing process, the controller 45 displays a message on the display of the PC 3 indicating that the suspension condition has occurred in the printing process on the printer 2.

Next, the process performed by the printer 2 will be described with reference to FIG. 4. The process beginning from S11 and the process beginning from S15 are initiated when the corresponding information is received from the PC 3. Therefore, the order in which each step is implemented is not necessarily in the order beginning from the lowest step number.

In S11 the controller 17 receives print data from the PC 3 through the endpoint EP1 of the USB interface 19. At this time, the controller 17 temporarily stores the print data in the receive buffer 18A.

Thereafter, the controller 17 starts executing a printing process based on the print data stored in the receive buffer 18A. Specifically, the controller 17 first executes a Raster Image Processor (RIP) process. The RIP process includes: an analysis process to sequentially analyze each of the multiple operators of PDF data included in the print data; a construction process to sequentially construct drawing objects (such as character strings, figures, and images specified by the operators identified in the analysis process) in an image space for one page; and a process to write the one-page image constructed in the construction process in the memory 18 as raster data, for example. After storing the raster data in the memory 18 in the above RIP process, the controller 17 waits until preparation operations of the image forming unit 13 are completed. Once the controller 17 determines that the preparation operations of the image forming unit 13 have been completed, the controller 17 controls the image forming unit 13 to execute an image forming operation to form an image on a sheet S based on the print data. Since an image forming operation with the image forming unit 13 has already been described with reference to FIG. 2, a description of this operation will be omitted.

In S12 the controller 17 determines whether the printing process based on the print data received in S11 is currently being executed. Here, the printing process includes the reception of the print data, the RIP process, and the post-analysis image forming operation. The reception of the print data is an example of the print data receiving process in the present disclosure.

When the controller 17 determines that the printing process based on the print data received in S11 has been completed (S12: NO), the controller 17 ends the process of FIG. 4. However, when the controller 17 determines that the printing process is in progress (S12: YES), the controller 17 advances to S13.

In S13 the controller 17 determines whether a suspension condition is present in the printing process (i.e., whether a suspension condition has occurred in the printing process). Here, the suspension condition denotes a condition under which the printing process is to be suspended. Examples of suspension conditions include a sheet jam occurring on the conveying path, and the printer 2 running out of sheets S. The controller 17 can detect the occurrence of a sheet jam on the conveying path (a state where a sheet jam has occurred on the conveying path) and the occurrence of a sheet-out condition (a state where the printer 2 has run out of sheets S) based on detection results of the sensors that detect sheets S passing along the conveying path, including the pre-registration sensor SE4, the post-registration sensor SE5, and the discharge sensor SE6. Other possible suspension conditions include: no available space remaining in the storage area of the receive buffer 18A of the printer 2; an error occurring during the RIP process (e.g., during the analysis of print data) in the printer 2; the front cover 21 of the printer 2 being open; and the supply tray 31 of the printer 2 being open.

When the controller 17 determines that a suspension condition is present in the printing process (S13: YES), in S14 the controller 17 suspends the printing process, and then returns to S13. In this case, the controller 17 waits until the suspension condition has been cleared while repeating the processes in S13 and S14. That is, this suspended printing process is resumed when the controller 17 subsequently determines that the suspension condition has been cleared (S13: NO). On the other hand, when the controller 17 determines that no suspension condition has occurred (S13: NO), the controller 17 returns to S12 and waits until the printing process is completed while repeating the processes in S12 and S13.

In S15, on the other hand, the controller 17 receives the status request command from the PC 3 through the endpoint EP0 of the USB interface 19. At this time, the controller 17 stores the received data in the receive buffer 18A.

Thereafter, the controller 17 performs PJL analysis to analyze the received status request command. In the present embodiment, status request commands are transmitted over the control transfer pipe P0, which differs from the pipe used to transmit print data. Therefore, status request commands typically are not retained in the pipe.

In S16 the controller 17 determines whether the analysis on the status request command received in S15 is currently in progress.

When the controller 17 determines that the analysis on the status request command is currently in progress (S16: YES), the controller 17 waits until the analysis is completed while repeating the process in S16. However, when the controller 17 determines that the analysis on the status command received in S15 has been completed (S16: NO), in S17 the controller 17 transmits status information to the PC 3 that is the source of the request (i.e., the PC 3 that issued the request) through the endpoint EP0 of the USB interface 19.

As with the status request command, the status information is transmitted in S17 over the control transfer pipe P0. Accordingly, the printer 2 can return status information without delay, even if print data is retained on a pipe. In particular, the printer 2 can also receive a status request command while a suspension condition is present in a printing process. The printer 2 can also return (transmit) status information to the PC 3 while a suspension condition is occurring in a printing process. FIG. 4 shows an example in which, in S17, the printer 2 returns status information to the PC 3 (that is the source of the request) during the period of time from S14 to S13, i.e., while a suspension is occurring in a printing process. However, the time when the printer 2 returns status information to the PC 3 that is the source of the request is not limited to this configuration. For example, the printer 2 may return (transmit) status information to the PC 3 in S17 during the period of time from S11 to S12. The printer 2 may also return (transmit) status information to the PC 3 in S17 during the period of time from S12 to S13 or during the period of time from S13 to S12. The printer 2 may also return (transmit) status information to the PC 3 in S17 after S12.

Here, a case will be described in which the status information returned by the printer 2 is information indicating the current status of the printer 2. In a state where a suspension condition is present in a printing process, the controller 17 returns status information indicating that the suspension condition has occurred in the printing process, i.e., status information including information indicating that the suspension condition has occurred in the printing process. The controller 17 may include, in the status information indicating that the suspension condition has occurred, information indicating what suspension condition has occurred. Specifically, the controller 17 may include, in the status information indicating that the suspension condition has occurred: information specifying a sheet jam when a sheet jam has occurred; information specifying an out-of-sheet error when the printer 2 has run out of sheets S; information specifying that no available space remains in the storage area of the receive buffer when the receive buffer 18A has run out of storage space; information specifying an error occurred in the RIP process (e.g., the analysis of print data) when an error has occurred in the RIP process (e.g., the analysis of print data); information specifying that the front cover is open when the front cover 21 is open; and information specifying that the supply tray is open when the supply tray 31 is open.

The above information is an example of the status information that the controller 17 transmits (returns) to the PC 3 in response to the status request command. When other suspension conditions occur, the controller 17 may include information specifying the other suspension condition in the status information, for example. In a state where a suspension condition is not occurring, the controller 17 may transmit (return) status information specifying “operating normally,” “printing,” “preparing to print,” “printing completed,” and the like. The controller 17 may include information specifying the current status of the printer 2 in the status information in addition to information indicating that a suspension condition has occurred in the printing process. As information specifying the current status of the printer 2, the controller 17 may include information on consumables used in the printer 2 in the status information. Information on consumables included in the status information may be information on the number of sheets remaining in the supply tray 31 of the printer 2, information on the quantity of toner remaining in the toner cartridge mounted in the printer 2, information on the remaining life of the drum cartridge mounted in the printer 2, and the like. The controller 17 can obtain such information from the memory 18 or from detection results of the sensors possessed by the printer 2.

After receiving the status information returned from the printer 2 in S17, the PC 3 provides guidance to the user regarding the status information and reflects the status information in the processing content of the PC 3 as appropriate. For example, when receiving status information indicating that a suspension condition is present, the PC 3 displays a screen on the display unit of the PC 3 notifying the user that the suspension condition has occurred. The screen that the PC 3 displays on the display unit of the PC 3 may also include information specifying what suspension condition has occurred.

In S17 described above, the controller 17 may always return all status information related to the printer 2 or may vary the content of the status information to be returned depending on the situation. For example, the PC 3 may transmit a status request command to the printer 2 at one or more of the following timings: (A) in response to a fixed period of time having elapsed since the PC 3 is connected to the printer 2; (B) before a printing process is executed (after receiving a print instruction but before transmitting the print data); and (C) in response to a predetermined period of time having elapsed since the PC 3 transmits print data. Note that the concept of (A) (“the PC 3 transmits a status request command to the printer 2 in response to a fixed period of time having elapsed since the PC 3 is connected to the printer 2”) may encompass (but does not necessarily encompass) the PC 3 transmitting a status request command to the printer 2 in response to a fixed period of time having elapsed after the previous command is transmitted (i.e., the PC 3 transmitting a status request command to the printer 2 at repeated intervals of the fixed period of time after the PC 3 is connected to the printer 2). Since the information suitable for the host side differs depending on the respective occasions, the controller 17 can change the type of status information to be transmitted for each occasion accordingly. Specifically, the status information returned by the controller 17 at timing (B) may be only information related to consumables used in the printer 2, and the status information returned at timings (A) and (C) may be only information specifying the current status of the printer 2. At any of these timings, when a suspension condition is present in the printing process, the controller 17 returns status information that includes information specifying that the suspension condition is present in the printing process.

Next, referring to FIG. 5, the control process for a case in which the printer 2 receives print data and a cancel command from the PC 3 will be described as a second working example. The following description assumes that the printer 2 and PC 3 are connected via a USB connection cable and that the aforementioned pipes between endpoints have been formed (see FIG. 3).

First, the process performed on the PC 3 will be described. In S21 the controller 45 transmits print data to the printer 2 through the endpoint EP01 of the USB interface 20. Since the process of S21 is identical to the process in S1 described above, a description will be omitted.

In S22 the controller 45 transmits a cancel command (a print cancellation command) to the printer 2. The cancel command is data described in PJL, and more specifically is a command requesting the printer 2 to cancel a printing process currently underway on the printer 2. The controller 45 transmits the cancel command in S22 in response to receiving a command to cancel a print from the user after transmitting the print data in S21, for example. However, the controller 45 can transmit a cancel command when predetermined conditions are met, independently of a user operation.

Data for the cancel command is transmitted in S22 using the control transfer pipe P0 shown in FIG. 3. In other words, in S22 the controller 45 transmits the cancel command to the printer 2 through the endpoint EP0 of the USB interface 20.

Next, the process performed on the printer 2 will be described with reference to FIG. 5. The process beginning from S31 and the process beginning from S39 are initiated when the corresponding information is received from the PC 3. Therefore, the order in which each step is implemented is not necessarily the order beginning from the lowest step number.

Since the process performed in S31 and S32 is identical to that in S11 and S12 described above, a description of this process has been omitted.

When the controller 17 determines that a printing process is in progress (S32: YES), in S33 the controller 17 determines whether a cancellation process has been executed. As will be described later, after receiving a cancel command from the PC 3 in S39, the controller 17 performs a cancellation process in S40 to cancel the printing process currently in progress. However, since the cancel command is received in S39 independently of reception of the print data in S31, a cancellation process may be executed while print data is being received.

When the controller 17 determines that a cancellation process has been executed (S33: YES), in S34 the controller 17 cancels the analysis process currently underway on the print data. Hence, when the cancellation process is performed after print data is received and stored in the receive buffer 18A and while the print data stored in the receive buffer 18A is being analyzed, the controller 17 does not perform any image formation based on that print data. When the cancellation process is executed prior to performing an analysis process, the controller 17 does not perform the analysis process (or the subsequent image formation) on print data already received or currently being received. However, when the cancellation process is executed after the analysis process is completed and an image formation process to perform image formation on a sheet S based on the received print data (and specifically, the formation of a toner image on the surface of the photosensitive drum 51, the transfer of the toner image to the sheet S, etc.) has already started, the controller 17 continues the started image formation process, but does not perform (i.e., cancels) image formation on a new page if the printing process covers multiple pages. As an alternative, even when an image formation process based on the received print data has been initiated, the controller 17 may be configured to cancel the image formation process in progress (i.e., to avoid subsequent image formation) at the point the cancellation process is executed. Note that a printing process may be canceled for reasons other than a cancel command being received from the PC 3. For example, in response to receiving a cancellation operation via the operating panel 15, the controller 17 may determine that a cancellation process has been executed (S33: YES).

However, when the controller 17 determines that a cancellation process has not been executed (S33: NO), the controller 17 returns to S32 and waits until the printing process is completed or a cancellation process has been executed while repeating the process in S32 and S33.

After the analysis process is canceled in S34, in S35 the controller 17 determines whether print data is being received at the time the cancellation process is executed (i.e., whether the cancellation process is executed while print data is being received).

When the controller 17 determines that print data is being received at the time the cancellation process is executed (S35: YES), in S36 the controller 17 cancels (terminates) the reception of print data. However, when the controller 17 determines that print data is not being received at the time the cancellation process is executed (S35: NO), the controller 17 ends the process in FIG. 5.

After canceling the reception of print data in S36, in S37 the controller 17 determines whether any part of the print data already received by the time the cancellation process has been executed (i.e., the time the reception of the print data is canceled in S36) is stored in the receive buffer 18A.

When the controller 17 determines that any part of the print data already received by the time the cancellation process is executed is stored (S37: YES), in S38 the controller 17 clears the already-stored part of the print data from the receive buffer 18A. Subsequently, the controller 17 ends the process in FIG. 5. However, when the controller 17 determines that any part of the print data already received by the time the cancellation process is executed is not stored in the receive buffer 18A (S37: NO), the controller 17 simply ends the process in FIG. 5.

On the other hand, in S39 the controller 17 receives a cancel command from the PC 3 through the endpoint EP0 of the USB interface 19. The data of the cancel command received from the PC 3 is stored in the receive buffer 18A.

Thereafter, the controller 17 executes a PJL analysis to analyze the received cancel command. In the present embodiment, cancel commands are transmitted over the control transfer pipe P0, which differs from the pipe used to transmit print data. Therefore, typically, cancel commands are not retained on the pipe.

In S40 the controller 17 executes a cancellation process based on the cancel command received in S39. As a result, a printing process that is in progress in S34-S38 described above is canceled in the middle of the process. FIG. 5 shows an example in which a cancel command is received in S39 during the period of time from S31 to S32, i.e., while print data is being received and before the RIP process and post-analysis image formation are executed. However, the timing at which the controller 17 receives a cancel command is not limited to this. For example, the controller 17 can receive a cancel command even during the process of S32, i.e., while at least one of the RIP process and post-analysis image formation process is underway (while just one of the RIP process and post-analysis image formation process is in progress; while both the RIP process and post-analysis image formation process are in progress; and of course after the reception of print data is complete or while print data is still being received). In this case, the cancellation process is executed while the print data is being received or while a printing process is being performed based on the part of print data that has already been received. The controller 17 can also execute a cancellation process while a suspension condition is occurring in a printing process.

As described above in detail, when the printer 2 of the present embodiment receives a status request command from the PC 3 (the USB-connected termina device) through the pipe and endpoints (e.g., the endpoints EP0) for control transfer while print data is being received through the pipe and endpoints (e.g., the endpoints EP1) for data transfer (e.g., print data communications), the printer 2 returns its own status information to the PC 3, which requested the status information, through the control transfer endpoints (S17). Therefore, the printer 2 can process status request commands through the control transfer endpoints, even when print data being sent from the PC 3 to the printer 2 is retained on the pipe due to the print data being of a large volume that requires time for transmission, for example. As a result, the PC 3 can obtain status information from the printer 2 at any timing. Moreover, the printer 2 can receive a status request command via the existing control transfer endpoints, without having to establish new endpoints dedicated to the transmission of status request commands. Further, the configuration of the USB interface is not made more complicated because the pipe connecting the control transfer endpoints can be used for bi-directional communications. Note that, in a configuration in which the endpoints of the USB interfaces 19 and 20 other than the endpoints EP0 (endpoints 0) can be set as the control transfer endpoints, the endpoints set as the control transfer endpoints may be used for transmission and reception of status request commands, cancel commands, and status information, in place of the endpoints EP0 (endpoints 0).

When the printer 2 receives a status request command through the control transfer endpoints after the printer 2 has received print data through the endpoints for data transfer and while this print data is being stored in the receive buffer 18A, the printer 2 returns its own status information to the PC 3 that is the source of the status request command via the control transfer endpoints (S17). Therefore, the printer 2 can process status request commands via the control transfer endpoints, even when print data sent from the PC 3 to the printer 2 is retained or buffered because a printing process cannot be executed due to a sheet jam or the depletion of consumables, for example.

When the printer 2 receives a status request command through the control transfer endpoints after the printer 2 has received print data through the endpoints for data transfer and while a suspension condition is present in a printing process based on the received print data, the printer 2 returns its own status information through the control transfer endpoints to the PC 3 that requested the status information (S17). Therefore, the printer 2 can process status request commands via the control transfer endpoints, even when a suspension condition is present in a printing process due to a sheet jam or the depletion of consumables, for example.

When the printer 2 receives a cancel command through the control transfer endpoints instructing the printer 2 to cancel a print while reception of print data through the data transfer endpoints, the printer 2 cancels (terminates) the reception of print data without performing the printing process based on the portion of the print data that has been received by the time the reception of the print data is canceled (S34, S36). Therefore, the printer 2 can process a cancel command via the control transfer endpoints, even when print data sent from the PC 3 to the printer 2 is retained in the pipe due to the print data being of a large volume that requires time for transmission, for example. As a result, the printer 2 can process a cancellation instruction from the PC 3 at any timing. In other words, the PC 3 can be given the same functionality for canceling a print as when an instruction to cancel a print is inputted directly through an operation on the printer body. Moreover, the configuration of the USB interface need not be more complicated because the cancel command can be received through the existing control transfer endpoints without needing to establish new endpoints dedicated to the transmission of cancel commands.

When the printer 2 receives a cancel command through the control transfer endpoints instructing the printer 2 to cancel a print after the printer 2 has received print data through the data transfer endpoints and while a printing process based on the received print data is in progress, the printer 2 cancels the printing process in progress based on the received print data (S34). Therefore, the printer 2 can process a cancel command received via the control transfer endpoints, even when print data transmitted from the PC 3 to the printer 2 has become retained or buffered because a printing process cannot be executed due to a sheet jam or the depletion of consumables, for example.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

For example, while the timing at which the PC 3 transmits a status request command to the printer 2 in the embodiment described above is one or more of the following: when a fixed time has elapsed since the PC 3 is connected to the printer 2, a timing prior to executing a printing process (after receiving a print instruction and prior to sending the print data), or when a predetermined time has elapsed since the print data is transmitted, other timings may be used. Since a status request command is processed via the control transfer pipe P0 and endpoints 0 (the endpoints EP0), the PC 3 can obtain status information from the printer 2 at any timing.

While a printer is used as an example of the image forming apparatus in the above embodiment, a multifunction peripheral which has, in addition to a printer function, a facsimile function, a copier function, and a scanner function may be used as the image forming apparatus. Further, the printer in the above embodiment may be an inkjet printer instead of a laser printer, as long as the printer can print on sheets S. In a case where an inkjet printer is used as the image forming apparatus, the information on a consumable, which is returned as status information, is information on the quantity of ink remaining in an ink cartridge mounted in the image forming apparatus, instead of the quantity of toner remaining in the toner cartridge mounted in the image forming apparatus.

In the above embodiment, information on consumables in use in the printer 2 and information indicating the current status of the printer 2 (“printing,” “error,” etc.) is returned as status information, but the printer 2 can also return the total number of pages printed on the printer 2 as status information.

What is claimed is:

1. An image forming apparatus comprising:
a Universal Serial Bus (USB) interface including:
a control endpoint for control transfer; and
a data endpoint for data transfer; and
a controller configured to perform:
transmitting, in response to receiving a status request command from a USB-connected terminal device through the control endpoint, status information of the image forming apparatus to the USB-connected terminal device through the control endpoint, the USB-connected terminal device being a terminal device connected to the image forming apparatus through a USB connection.

2. The image forming apparatus according to claim 1,
wherein the controller receives the status request command from the USB-connected terminal device through the control endpoint while receiving print data from the USB-connected terminal device through the data endpoint.

3. The image forming apparatus according to claim 1, further comprising:
a receive buffer,
wherein the controller receives the status request command from the USB-connected terminal device through the control endpoint after receiving print data from the USB-connected terminal device through the data endpoint and while the received print data is being stored in the receive buffer.

4. The image forming apparatus according to claim 1,
wherein the controller receives the status request command from the USB-connected terminal device through the control endpoint after receiving print data from the USB-connected terminal device through the data endpoint and while a suspension condition is present in a printing process based on the received print data, the suspension condition being a condition under which the printing process is to be suspended.

5. An image forming apparatus comprising:
a Universal Serial Bus (USB) interface including:
a control endpoint for control transfer; and
a data endpoint for data transfer; and
a controller configured to perform:
canceling, in response to receiving a print cancellation command from a USB-connected terminal device through the control endpoint while a printing process is in progress, the printing process in progress, the USB-connected terminal device being a terminal device connected to the image forming apparatus through a USB connection.

6. The image forming apparatus according to claim 5,
wherein the printing process includes:
a print data receiving process to receive print data from the USB-connected terminal device through the data endpoint; and
an image formation process to perform image formation on a sheet based on the print data, and
wherein, when receiving the print cancellation command from the USB-connected terminal device through the control endpoint while the print data receiving process is in progress, in the canceling the controller cancels the print data receiving process in progress without performing the image formation process based on a portion of the print data that has been received by the time the print data receiving process is canceled.

7. The image forming apparatus according to claim 5,
wherein the printing process includes:
a print data receiving process to receive print data from the USB-connected terminal device through the data endpoint; and
an image formation process to perform image formation on a sheet based on the print data, and
wherein, when receiving the print cancellation command from the USB-connected terminal device through the control endpoint after the print data receiving process is completed and while the image formation process based on the received print data is in progress, in the canceling the controller cancels the image formation process in progress.

8. The image forming apparatus according to claim 1,
wherein the controller is configured to further perform:
canceling, in response to receiving a print cancellation command from the USB-connected terminal device through the control endpoint during reception of print data from the USB-connected terminal device through the data endpoint, the reception of the print data without performing image formation based on a portion of the print data that has been received by the time the reception of the print data is canceled.

9. The image forming apparatus according to claim 1,
wherein the controller is configured to further perform:
canceling, in response to receiving a print cancellation command from the USB-connected terminal device through the control endpoint after receiving print data from the USB-connected terminal device through the data endpoint and while a printing process based on the received print data is in progress, the printing process in progress.

10. The image forming apparatus according to claim 1,
wherein, in the transmitting, the controller transmits, as the status information, at least one of:
information on one or more consumables in use in the image forming apparatus; or
information indicating a current status of the image forming apparatus, and
wherein the information on the one or more consumables includes at least one of:
information on the number of sheets remaining in the image forming apparatus;
information on a quantity of toner remaining in a toner cartridge mounted in the image forming apparatus; or
information on a remaining life of a drum cartridge mounted in the image forming apparatus.

11. The image forming apparatus according to claim 1,
wherein, in the transmitting, the controller transmits, as the status information, at least one of:
information on one or more consumables in use in the image forming apparatus; or
information indicating a current status of the image forming apparatus, and
wherein the information on the one or more consumables includes at least one of:
information on the number of sheets remaining in the image forming apparatus; or
information on a quantity of ink remaining in an ink cartridge mounted in the image forming apparatus.

12. The image forming apparatus according to claim 1,
wherein, when the controller receives the status request command from the USB-connected terminal device through the control endpoint while a suspension condition is present in a printing process performed by the image forming apparatus, the status information that is transmitted to the USB-connected terminal device in the transmitting indicates that the suspension condition is present in the printing process performed by the image forming apparatus, the suspension condition being a condition under which the printing process is to be suspended.

13. The image forming apparatus according to claim 1, further comprising:
a receive buffer,
wherein, when the controller receives the status request command from the USB-connected terminal device through the control endpoint while no available space remains in a storage area of the receive buffer, the status information that is transmitted to the USB-connected terminal device in the transmitting indicates that no available space remains in the storage area of the receive buffer of the image forming apparatus.

14. The image forming apparatus according to claim 1,
wherein, when the controller receives the status request command from the USB-connected terminal device through the control endpoint while an error is present in an analysis of print data received through the data endpoint, the status information that is transmitted to the USB-connected terminal device in the transmitting indicates that the error is present in the analysis of the received print data.

15. The image forming apparatus according to claim 1, further comprising:
a cover configured to be opened and closed; and
a sensor configured to detect an open and closed state of the cover,
wherein, when the controller receives the status request command from the USB-connected terminal device through the control endpoint while the cover is open, the status information that is transmitted to the USB-connected terminal device in the transmitting indicates that the cover is open.

16. The image forming apparatus according to claim 1, further comprising:
a sheet tray for accommodating a sheet; and
a sensor configured to detect an open and closed state of the sheet tray,
wherein, when the controller receives the status request command from the USB-connected terminal device through the control endpoint while the sheet tray is open, the status information that is transmitted to the USB-connected terminal device in the transmitting indicates that the sheet tray is open.

17. An image forming system comprising:
an image forming apparatus; and
a terminal device connected to the image forming apparatus through a Universal Serial Bus (USB) interface including:
a control endpoint for control transfer; and
a data endpoint for data transfer,
wherein the terminal device is configured to perform:
transmitting a status request command to the image forming apparatus through the control endpoint; and
transmitting print data to the image forming apparatus through the data endpoint, and
wherein the image forming apparatus is configured to perform:
transmitting, in response to receiving the status request command from the terminal device through the control endpoint, status information of the image forming apparatus to the terminal device through the control endpoint.

18. The image forming system according to claim 17,
wherein the image forming apparatus receives the status request command from the terminal device through the control endpoint while receiving print data from the terminal device through the data endpoint.

19. The image forming system according to claim 17, further comprising:
a receive buffer,
wherein the image forming apparatus receives the status request command from the terminal device through the control endpoint after receiving print data from the terminal device through the data endpoint and while the received print data is being stored in the receive buffer.

20. The image forming system according to claim 17,
wherein the image forming apparatus receives the status request command from the terminal device through the control endpoint after receiving print data from the terminal device through the data endpoint and while a suspension condition is present in a printing process based on the received print data, the suspension condition being a condition under which the printing process is to be suspended.
